(19) United States
(12) Patent Application Publication
(10) Pub. No.: US 2004/0155177 A1
(43) Pub. Date: Aug. 12, 2004

(54) Method for supressing mutual interference of an optical multi-sensor system and corresponding multi-sensor system

(76) Inventor: Manfred Schmitt, Hahnbach (DE)

Correspondence Address: HARNESS, DICKEY & PIERCE, P.L.C., P.O.BOX 8910, RESTON, VA, 20195, US

(21) Appl. No.: 10/474,871

(22) PCT Filed: Mar. 28, 2002
(86) PCT No.: PCT/DE02/01171

(30) Foreign Application Priority Data
Apr. 10, 2001 (DE) 101 17 896.4

(51) Int. Cl. G06M 7/00

(52) U.S. Cl. 250/221

(57) ABSTRACT

A method for suppressing mutual interference in optical sensors without additional control or installation requirement and a corresponding multi-sensor system are disclosed. The sensors (13) receive communication calls, by means of a bus (14), with which time windows for the transmission and receiving of light impulses are synchronised. Said multi-sensor system is provided with a control module, which serves for data exchange with the sensors (13) during the communication call by means of a bus (14), whereby a parameterisation of the sensors (13) occurs by means of which the time windows are fixed.

Method for suppressing mutual influencing in an optical multiple sensor system, and associated multiple sensor system

The invention relates to a method for suppressing mutual influencing in an optical system with a plurality of optical sensors, which are respectively connected to a control module via a line and which emit and receive light pulses within time windows, the temporal occurrence of the time windows being controlled. In addition, the invention relates to a multiple sensor system for carrying out the abovementioned method.

Binary sensors are used in large numbers for automation e.g. in the automotive industry or in machine tool construction. In this case, the sensors are connected to the controller or the decentralized peripherals either via conventional parallel wiring or via field bus systems. The methods known here for suppressing mutual influencing in the optical sensors and the optical multiple sensor systems used are described in more detail below.

FIG. 1 schematically illustrates part of a parallel-wired system. It has a central processing unit 1 with an input/output assembly 2. The central processing unit 1 and the assembly 2 are connected to one another and to a power supply assembly 4 via an internal control bus 3. The illustration in FIG. 1 does not show actuators, e.g. solenoid valves, which are present in practically every installation. Two sensors 5 are illustrated as representative of all further sensors, for which only connections 6 are symbolically indicated.

The connection between the assembly 2 and the sensors 5 is generally effected via a three-wire line 7. Two of these lines serve for supplying energy and via the third the binary signal is communicated from the sensor to the assembly 2. During assembly, care must be taken to ensure that the individual lines of the three-wire line 7 are connected correctly since malfunctions, in the extreme case even destruction of the sensors, can otherwise occur.

Generally, although the sensors are provided with protective measures, such as polarity reversal protection and short-circuit protection, this is relatively costly.

The sensors 5 may be based on different functional principles. By way of example, they may be optical sensors 5. During operation, optical sensors 5 generally emit a correspondingly short light pulse periodically only in a short time window. The time window is controlled by a sensor-internal clock stage. The emitted light is also detected only in this time window. Since all the sensors 5 operate autonomously and are not normally synchronized or triggered, mutual influencing can occur, under certain circumstances, if the time windows of two sensors 5 randomly coincide and one sensor 5 detects the light pulse of another sensor 5 (cross talk).

The problem of cross talk can be eliminated by the presence of additional control inputs at the relevant sensors 5. Via the additional control inputs, drive pulses are communicated to the individual sensors 5 from an additional control unit 9 via additional control lines 10. As a result, the sensors 5 can be driven in temporally staggered fashion, so that cross talk is precluded.

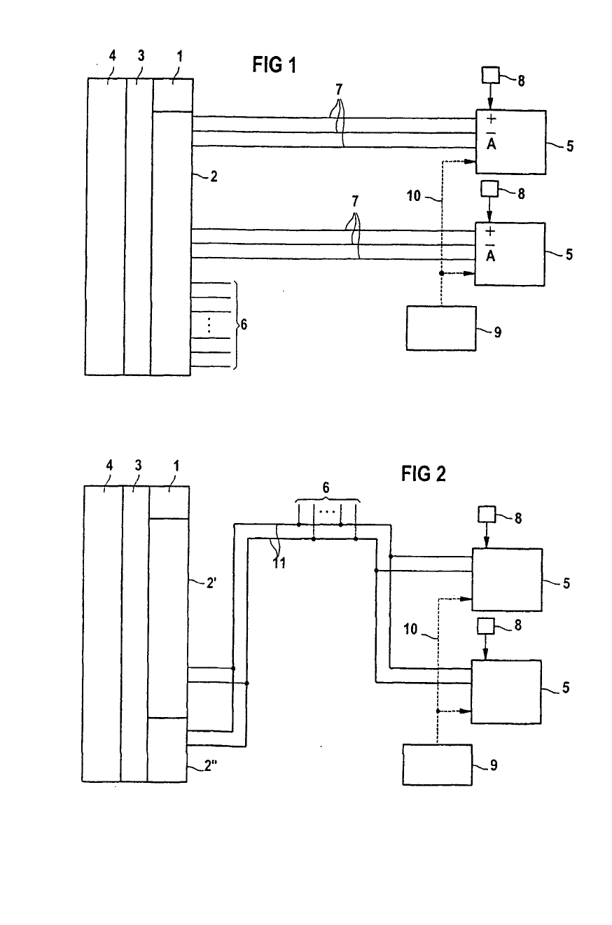

FIG. 2 schematically illustrates the same subsystem as in FIG. 1, but here the switching signal transfer from the sensor to the controller is effected via a field bus system, which is explained below using the example of the actuator-sensor interface (AS-I). The voltage supply 4, the internal control bus 3, the stored-program controller or decentralized peripherals (SPC/DP) 1 and the connections 6 to further subscribers correspond to those in FIG. 1. The AS interface is a field bus system for the networking of sensors and actuators. This requires an AS-I master 2′, an AS-I power supply unit 2″ and special sensors 5 with an integrated communication chip, which are all connected to one another via a two-wire line 11 (data and energy for subscribers). The AS-I master 2′ is connected to the SPC/DP 1 instead of an input/output assembly and only controls the data exchange between SPC/DP and the actuators (not illustrated) or sensors 5. Although here, in principle, a targeted triggering of the sensors by the SPC/DP would be possible in the context of the above-described problem of mutual influencing (e.g. optical sensor), the extremely short possible trigger pulse interval between two sensors nevertheless results from the user program cycle time or the AS-I cycle time, which means that “real-time object detection” by the sensor is impossible. In practice, therefore, all that remains is also the solution by means of an additional control unit 9 and additional lines 10, as has already been described above in the case of parallel wiring.

The invention is based on the object of proposing a method for suppressing mutual influencing in optical sensors without an additional control or wiring outlay. The further object is to specify a multiple sensor system suitable for this.

The first object is achieved by means of a method of the type mentioned above having the following steps:

a) communication calls are transmitted to the sensors via the line, which is in each case embodied as a bus,

b) the time windows are synchronized with the communication calls,

c) in each case the same number of time windows being provided between two communication calls, for the sensors.

A particularly advantageous development of the method exists if the time interval between two communication calls for each sensor is an integer multiple of its time window intervals.

Furthermore, it is advantageous if the sensors emit the light pulses in identical time window intervals between two communication calls.

Further advantageous designs of the invention can be gathered from subclaims 4 to 6.

The further object of providing a multiple sensor system of the abovementioned type is achieved by virtue of the fact that the lines in each case serve as a bus for the transfer of data during a communication call by a control module, and that the control module is provided as an input assembly which serves for data exchange with the sensors during the communication call via the respectively associated bus, a parameterization of the sensors taking place by way of the data exchange, said parameterization defining the synchronization of the time windows with the communication calls.

Further advantages and details emerge from the description below of an exemplary embodiment in conjunction with the drawings, in which in schematic illustration:

FIG. 1, FIG. 2 show control systems of the prior art,

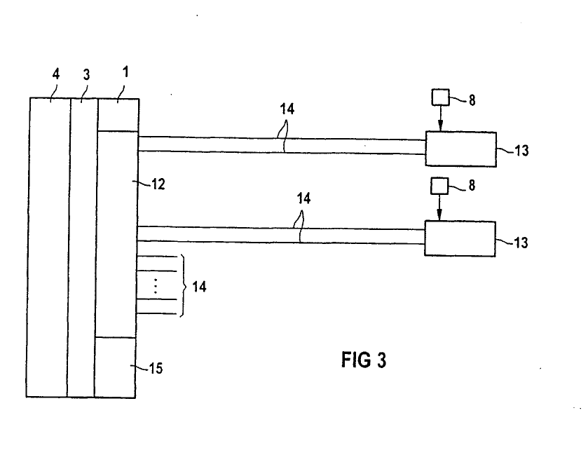

FIG. 3 shows a control system with a multiple sensor,

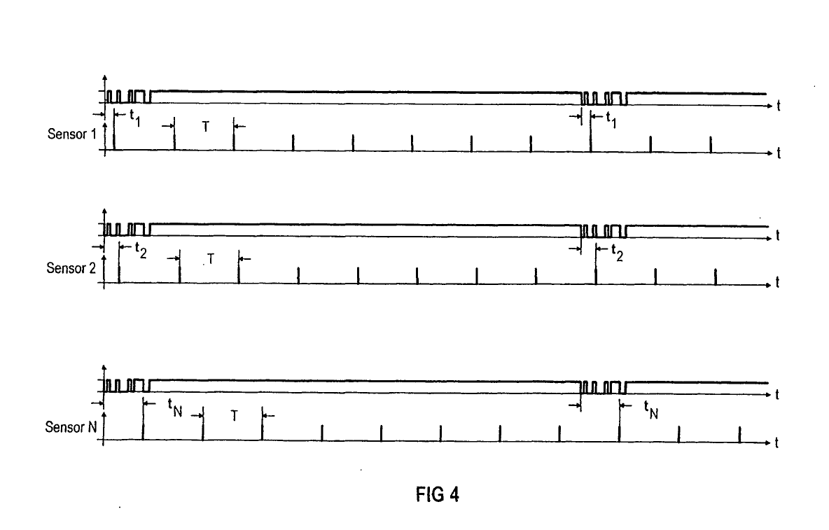

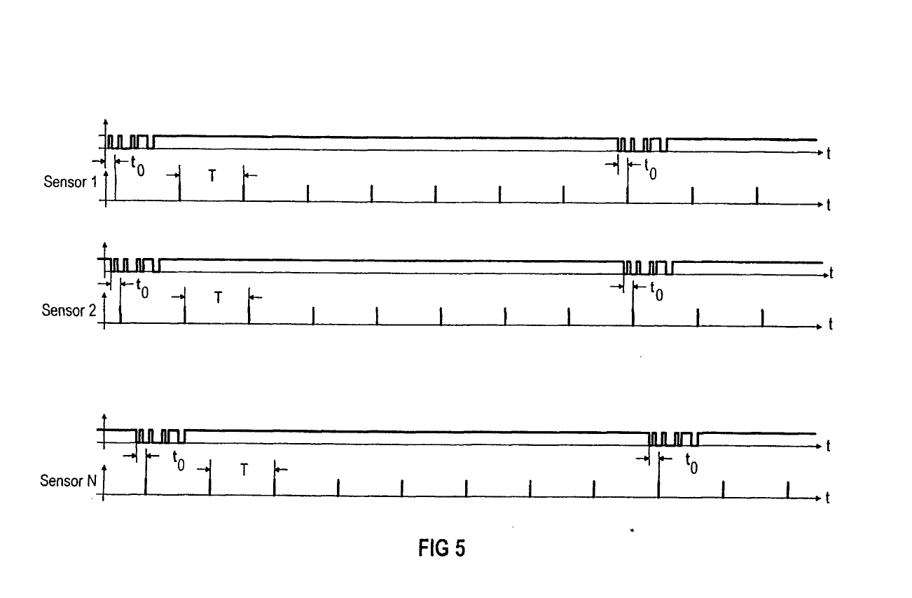

FIG. 4 shows a method according to the invention for the synchronization of time windows with simultaneous communication calls and correspondingly offset time windows with identical time window intervals,

FIG. 5 shows a method according to the invention for the synchronization of time windows with non-simultaneous communication calls and identical time window intervals,

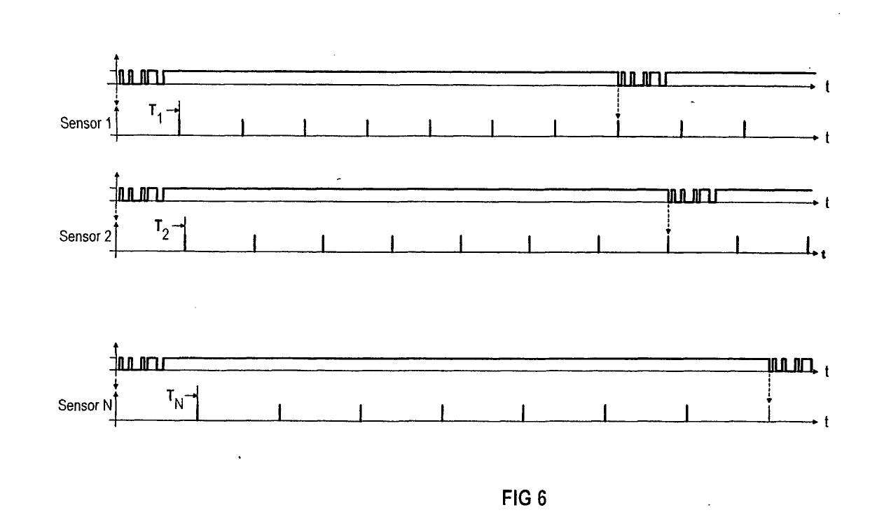

FIG. 6 shows a method according to the invention for the synchronization of time windows with different communication call intervals and non-identical time window intervals, and

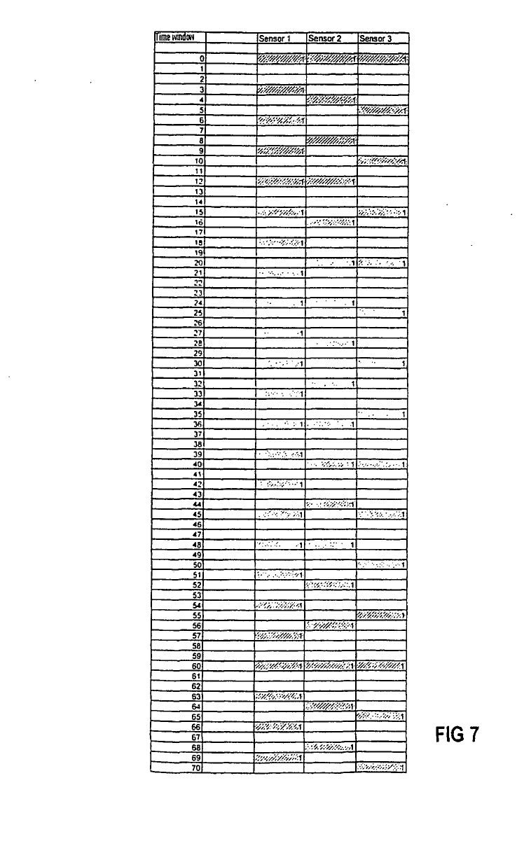

FIG. 7 shows the principle for suppressing mutual disturbing light influencing using the example of reflected light barriers.

The invention's method for suppressing mutual influencing is based on a multiple sensor system with control modules in accordance with FIG. 3. The multiple sensor system comprises a control module 12 and a plurality of sensors 13. In this case, only two sensors are illustrated in FIG. 3, but the number of sensors 13 is, in principle, as desired. The sensors 13 are connected to the control module 12 via proprietary two-wire lines 14. Via the two-wire lines 14 assigned to each sensor 13 in a proprietary manner, the sensors 13 are supplied with electrical energy and in addition data are communicated between the control module 12 and the respective sensor head 13.

The control module 12 is connected to the central processing unit 1 and the power supply assembly 4 via the control bus 3. The central processing unit 1 is furthermore connected to at least one output assembly 15 via the control bus 3. This output assembly 15 is unimportant in the context of the present invention, however, and so it is not discussed any further below. The sensors 13 can be parameterized by the controller or the control module 12.

The suppression of influencing can be realized with the abovementioned multiple sensor system according to the following methods:

assignment of individual time windows to each sensor with an identical time window interval,

operation of individual sensors with different time window intervals,

combination of the two methods.

The temporal relationship between the communication calls of the control module 12 (or a plurality thereof) and the time windows, i.e. the time ranges in which the individual optical sensors 13 emit light and also evaluate received light signals, is illustrated in accordance with FIG. 4. Each sensor 13 (No. 1, 2, . . . N) is assigned, e.g. by way of automatic parameterization by the control module 12, a dedicated time window with the reference time t_{μ}, which time window relates to the communication call by the control module 12. In this case, the interval between two communication calls is an integer multiple of the time window intervals T, resynchronization being effected with each communication call in order to correct time errors. This ensures that no sensor is disturbed by the light from another sensor. The same effect can be achieved if the reference time to in each sensor 13 is identical and the communication calls by the control module 12 are correspondingly temporally offset. This relationship is illustrated in FIG. 5.

The abovementioned condition where the interval between two communication calls is an integer multiple of the time intervals T is advantageous, but a solution in which this condition is not met is also conceivable. An alternative is afforded by operating the individual sensors 13 with different time window intervals T₁, T₂ . . . T_{N}. A prerequisite for this method is that, in the sensors 13, the assessed signals of a plurality of successive time windows are logically combined with one another. Furthermore, the time window intervals T₁, T₂ . . . T_{N} of the individual sensors 13 are to differ at least by a time window duration in each case (see FIG. 6). The intervals of the communication calls are also correspondingly adapted and amount to an integer multiple of the time window intervals.

N=number of sensors

Z=number of logically combined light signal assessments (bits)

M=minimum number of uncorrupted bits

T₁=time window interval for sensor No. 1

T₂=time window interval for sensor No. 2

T_{N}=time window interval for sensor No. N

T_{Z}=duration of a time window

ΔT=difference between shortest and longest time window interval

The method is described using the example of the number of sensors N=5, but can be applied to any other values if the conditions below are complied with. The requirement here shall be that only a single light window is corrupted by any other sensor. Furthermore, for example M=2 light windows are to be uncorrupted. This means that

Z=M+N−1=2+5−1=6

Time windows (bits) must be combined with one another. Since 5 sensors are involved in the example, the difference ΔT between the shortest and longest time window interval is

ΔT=(N−1)*T_{Z}=4*T_{Z}

In order that in each case a maximum of one light window is corrupted, the shortest time window interval (minimum value) is calculated as

T₁=Z*ΔT=6*4*T_{Z}=24*T_{Z}

The remaining time window intervals accordingly amount to 25 T_{Z}, 26 T_{Z}, 27 T_{Z} and 28 T_{Z}.

In this case, the value 24*T_{Z} for T₁ represents the lower limit at which the conditions are reliably met. In some instances there are combinations with smaller numerical values which likewise meet the requirements.

As already mentioned above, the two methods can also be combined.

With reference to FIG. 7, the principle for suppressing mutual disturbing light influencing will be explained using the example of reflected light barriers and the numerical values mentioned below. In reflected light barriers, the light beam is interrupted by an object possibly present, which means that no light is received in the relevant time windows.

| | |
|---|---|
| Number of sensors | N = 3 |
| Minimum number of uncorrupted | M = 1 |
| time windows (bits) | |
| Number of bits logically combined | Z = 3 |
| with one another | |
| Time window interval sensor No. 1 | T₁ = 3 * T_{z} |
| Time window interval sensor No. 2 | T₂ = 4 * T_{z} |
| Time window interval sensor No. 3 | T₃ = 5 * T_{z} |

According to the formula of the application document, the minimum value for T₁ would be T₁=6*T_{Z}, but the example is a combination for which, as mentioned above, the requirements are met even for smaller values for T_{V}.

The individual time windows are numbered consecutively from 0 to 70 in the first column of FIG. 1, those windows in which the relevant sensors emit and, if appropriate, receive light (light windows) being hatched in columns 3 to 5. The period duration of the “light pattern” results from the product of the individual time window intervals 3*4*5=60, which means that all possible combinations are detected. However, since three light windows (3 bits) are combined with one another successively, the table has been lengthened by the time windows 61 to 70, which are identical to the time windows 1 to 10 owing to the periodicity.

In the case of sensor No. 1, by way of example, the signals of the time windows 0, 3 and 6 (3 bits), the signals of the time windows 3, 6 and 9, the signals of the time windows 6, 9 and 12, and so on are successively combined with one another in each case. The combination in the other two sensors takes place analogously to the light windows thereof.

If the light windows of two or more sensors coincide (e.g. light windows Nos. 0, 12, 15, 20, etc.), then it may be that, by way of example, although an object is present in the light beam of sensor No. 1 and its light beam has actually been interrupted, the sensor nonetheless receives light from the other sensors.

The combination condition reads, in accordance with the abovementioned numerical values:

if M=no light is received 1 time in the Z=3 light windows, then an object is present in the beam path!

The condition means that at most 2 of the 3 combined light windows are permitted to be corrupted, if appropriate, by light from the other two sensors (extraneous light), while the light signal of the remaining light window can exclusively originate from the sensor itself and is thus valid.

The combined light windows 9, 12 and 15 shall be mentioned here as an example for sensor No.1, of which the light window 12 may be corrupted by sensor No. 2 and the light window 15 may be corruped by sensor No. 3, if appropriate.

1. A method for suppressing mutual influencing in an optical system with a plurality of optical sensors (13), which are respectively connected to a control module (12) via a dedicated line (14) and which emit and receive light pulses within time windows, the temporal occurrence of the time windows being controlled,
characterized by the following steps:
a) communication calls are transmitted to the sensors (13) via line (14),
b) the time windows are synchronized with the communication calls,
c) in each case the same number of time windows being provided between two communication calls, for the sensors (13) and
d) the communication calls of the sensors (13) having a constant time reference with respect to one another.

2. The method as claimed in claim 1, characterized in that the time interval between two communication calls for each sensor is an integer multiple of its time window intervals T.

3. The method as claimed in claim 1 or 2, characterized in that the sensors (13) emit the light pulses in identical time window intervals between two communication calls.

4. The method as claimed in one of the above-mentioned claims,
characterized in that the communication calls for the sensors (13) take place at the same time, and in that the reference time of the time window occurring first after each communication call is different for each sensor (13) without two time windows of different sensors (13) overlapping.

5. The method as claimed in one of the above-mentioned claims, characterized in that the communication calls for the sensors (13) do not take place at the same time and the reference time of the time window occurring after the first communication call is identical for each sensor (13).

6. The method as claimed in claim 2, characterized in that the time window intervals (T) between two successive time windows for the sensors differ at least by a time window duration δt in each case.

7. A multiple sensor system with a plurality of optical sensors (13), which are respectively connected to a common control module (13) via a line (14) and which emit and receive light pulses within time windows, the occurrence of the time windows being controlled temporally, characterized in that the lines serve for the transfer of data during a communication call by a control module (12), in that the control module (12) is provided as an input assembly which serves for data exchange with the sensors (13) during the communication call [lacuna] the respectively associated line (14), a parameterization of the sensors (13) taking place by way of the data exchange, said parameterization defining the synchronization of the time windows with the communication calls and in that the communication calls of the sensors (13) have a constant time reference with respect to one another.
